(19) United States
(12) Patent Application Publication
(10) Pub. No.: US 2006/0285352 A1
(43) Pub. Date: Dec. 21, 2006

(54) Optical device, apparatus and method for fabricating the optical device, backlight unit using the optical device, and liquid crystal display device using the backlight unit

(75) Inventor: Jun Sik Kim, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 11/288,256

(22) Filed: Nov. 29, 2005

(30) Foreign Application Priority Data
Jun. 17, 2005 (KR) P 2005-052671
Oct. 25, 2005 (KR) P 2005-100627

(51) Int. Cl. F21V 11/00; F21V 7/04

(52) U.S. Cl. 362/558; 362/561

(57) ABSTRACT

A backlight unit includes a light source, a diffusion plate that is disposed on the light source and provided with a plurality of beads for diffusing a light from the light source such that the density of the beads is varied, and a plurality of optical sheets disposed on the diffusion plate.

This application claims the benefit of the Korean Patent Application Nos. P2005-52671 and P2005-100627 filed on Jun. 17, 2005 and on Oct. 25, 2005, respectively, which are hereby incorporated by reference.

### BACKGROUND OF THE INVENTION

1. Field of the Invention

The present invention relates to a liquid crystal display (LCD) device, and more particularly to an optical device that is capable of slimming the thickness of an LCD device, a method and an apparatus of fabricating the optical device, a backlight unit using the optical device, and an LCD device using the backlight unit.

2. Discussion of the Related Art

The use, in general, of LCD devices is a broadening trend because of its characteristics of lightness, thinness, efficiency in power consumption, and so on. According to this trend, the LCD device is widely utilized in office automation equipment, audio/video equipment, and so on. However, the LCD device controls the transmitted amount of light in accordance with a video signal applied to a plurality of control switches that are arranged in a matrix form, thereby displaying a desired picture on a screen. In this way, the LCD device is not a self luminous display device, and thus requires a separate light source such as a backlight.

The backlight can be a direct type or an edge type in accordance with the location of a light source thereof. The edge type backlight has the light source installed at the edge of one side of an LCD device, and irradiates an incident light from the light source to an LCD panel through a light guide panel and a plurality of optical sheets. The direct type backlight has a plurality of light sources disposed right under the LCD device, and irradiates the incident light from the light sources to the LCD panel through a diffusion plate and a plurality of optical sheets. A cold cathode fluorescent lamp (CCFL) or a light emitting diode (LED) can be used as the light source of the backlight. Recently, the direct type backlight, which is brighter than the edge type backlight and has better light uniformity and color purity, has been utilized more for LCD TVs.

Referring to FIG. 1, a related art LCD device includes an LCD panel 10 for displaying a picture, a top case 20 disposed on the LCD panel 10, and a direct type backlight unit disposed at a rear surface of the LCD panel 10 to irradiate light to the LCD panel 10. In the LCD panel 10, a plurality of data lines and a plurality of scan lines are arranged to cross each other, and liquid crystal cells are arranged in an active matrix form between upper and lower substrates, thereby displaying a picture (not shown). The backlight unit includes a plurality of lamps 4, a bottom cover 3, a reflection plate 7, a diffusion plate 2, a plurality of optical sheets 5 and a wire 9.

The plurality of lamps 4 are CCFLs and are arranged in series. Herein, the wire 9 is connected to an external power source that drives the plurality of lamps 4. The bottom cover 3 includes a bottom surface and a side surface. The reflection plate 7 is disposed within the bottom cover 3. The optical sheets 5 include a diffusion sheet and a prism sheet-to have the incident light from the diffusion plate 2 uniformly irradiated to the whole of the LCD panel 10. The optical sheets 5 serve to increase the brightness in front of a display surface of the LCD panel 10 by bending the progress path of light in a direction perpendicular to the display surface. The diffusion plate 2 is located on the lamps 4 and provided with a plurality of beads included in PPMA (polymethylmethacrylate). The diffusion plate 2 utilizes the beads to disperse the incident light from the lamps 4 so as to make no brightness difference between a place where the lamps 4 are located in the display surface and a place where the lamps 4 are not located. In the related art of FIG. 1, the brightness difference can be removed only when the distance between the diffusion plate 2 and the lamp 4 is sufficiently secured.

According to the related art, since the diffusion plate 2 of the backlight unit has a uniform transmittance, the bright difference in accordance with the location of the lamps 4 cannot be eliminated only with the diffusion plate 2. Therefore, in the related art, the distance between the lamps 4 and the diffusion plate 2 should be secured sufficiently so as to remove the brightness difference in accordance with the location of the lamps 4. As a result, the thickness of the LCD device is undesirably increased.

### SUMMARY OF THE INVENTION

Accordingly, the present invention is directed to an optical device for a liquid crystal display (LCD) device, which substantially obviates one or more of the problems due to limitations and disadvantages of the related art.

An object of the present invention is to provide an optical device that is capable of slimming the thickness of the LCD device.

Another object of the present invention is to provide a method and an apparatus of fabricating the optical device for the LCD device.

Still another object of the present invention is to provide a backlight unit using the optical device and an LCD device using the backlight unit,

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an optical device for a light source in a liquid crystal display device includes a diffusion plate including a first diffusion part and a second diffusion part such that the light source emits a first amount of light to the first diffusion part and a second amount of light to the second diffusion part, and a plurality of beads included in both the first diffusion part and the second diffusion part, wherein the density of the beads in the first diffusion part is different from that in the second diffusion part.

In another aspect, a backlight unit includes a light source, a diffusion plate disposed on the light source and including a plurality of beads for diffusing a light from the light source, wherein the density of the beads is uneven, and a plurality of optical sheets disposed on the diffusion plate.

Still in another aspect, a backlight unit includes a light source, a diffusion plate disposed on the light source to diffuse a light from the light source, and a plurality of optical sheets disposed on the diffusion plate, wherein the plurality of optical sheets includes at least one diffusion sheet that is provided with a plurality of beads, and the density of the beads is varied.

Still in another aspect, a liquid crystal display (LCD) device includes a backlight unit including a light source, a diffusion plate disposed on the light source, and a plurality of optical sheets disposed on the diffusion plate, and an LCD panel electrically controlling a liquid crystal to modulate a light irradiated from the backlight unit, thereby displaying a picture, wherein the diffusion plate is provided with a plurality of beads for diffusing a light from the light source, and the density of the beads is varied.

Still in another aspect, a liquid crystal display (LCD) device includes a backlight unit including a light source, a diffusion plate disposed on the light source to diffuse a light from the light source, and a plurality of optical sheets disposed on the diffusion plate, and an LCD panel electrically controlling a liquid crystal to modulate a light irradiated from the backlight unit, thereby displaying a picture, wherein the plurality of optical sheets include at least one diffusion sheet that is provided with a plurality of beads, and the density of the beads is varied.

Still in another aspect, a method for fabricating an optical device includes providing a first transparent resin mixed with first beads on a moving stage through a first supply path and providing a second transparent resin mixed with second beads on the moving stage through a second supply path, wherein the number of the second beads are more than that of the first beads, curing the first and second transparent resins provided to the moving stage, and separating the first and second transparent resins from the moving stage.

Still in another aspect, a method for fabricating an optical device includes mixing a first beads with a liquefied transparent resin in uniform, aligning a mask including an open part and a shielding part on the liquefied transparent resin, providing the liquefied transparent resin with a second beads through the open part of the mask, and curing the liquefied transparent resin mixed with the first and second beads, wherein the density of the first beads is different from that of the second beads in the cured transparent resin.

Still in another aspect, a method for fabricating an optical device includes aligning a mask including an open part and a shielding part on a liquefied transparent resin, providing the liquefied transparent resin with a first beads through the open part of the mask, moving the mask, providing the liquefied transparent resin with a second beads through the open part of the mask, and curing the liquefied transparent resin mixed with the first and second beads wherein the density of the first beads is different from that of the second beads in the cured transparent resin.

Still in another aspect, an apparatus of fabricating an optical device includes a provider including a first supplying path for supplying a first transparent resin mixed with a first beads and a second supplying path for supplying a second transparent resin mixed with a second beads, a plurality of barrier ribs formed on the provider for dividing the first supplying path and the second supplying path, and a moving stage for receiving the first and second transparent resins from the provider.

Still in another aspect, an apparatus of fabricating an optical device includes a mask including an opening part and a shielding part, wherein a plurality of beads is provided through the opening part to a liquefied transparent resin in various densities.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram illustrating a liquid crystal display (LCD) device according to the related art;

FIG. 2 is a diagram illustrating an LCD device according to an exemplary embodiment of the present invention;

FIG. 3 is a diagram illustrating a diffusion plate shown in FIG. 2 in detail;

FIG. 4 is a diagram illustrating a general principle of light;

FIG. 5 is a diagram illustrating light paths passing through a diffusion plate according to an exemplary embodiment of the present invention;

FIG. 6 is a diagram illustrating a display surface when the related art backlight unit is used;

FIG. 7 is a diagram illustrating a display surface when a backlight unit of one exemplary embodiment of the present invention is used;

FIG. 8 is a perspective view of a diffusion plate according to one exemplary embodiment of the present invention;

FIGS. 9A to 9D are sectional views showing the method of fabricating the diffusion plate of FIG. 8; and

FIGS. 10A to 10D are sectional views showing the method of fabricating a diffusion plate according to another exemplary embodiment of the present invention

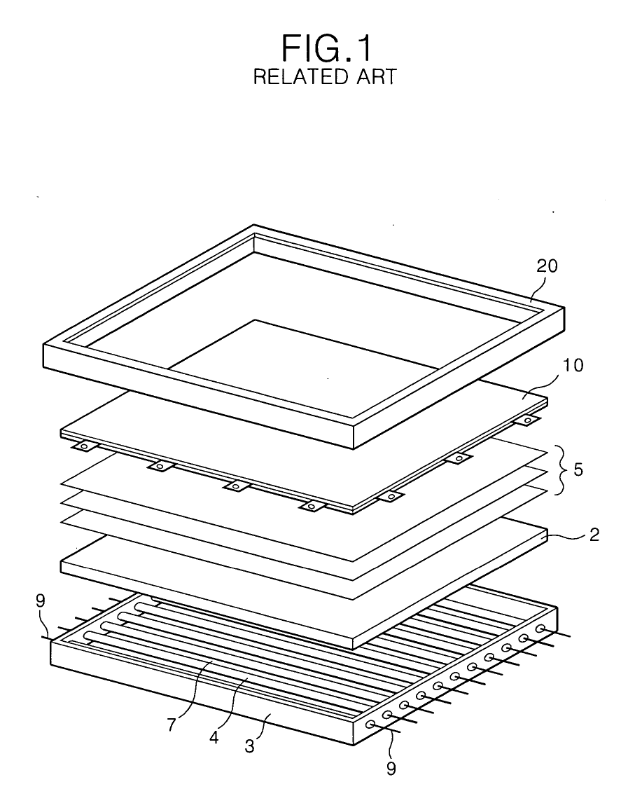

### DETAILED DESCRIPTION OF THE PREFERRED EMBODIMENT

Reference will now be made in detail to the preferred embodiments of the present invention, examples of which are illustrated in the accompanying drawings.

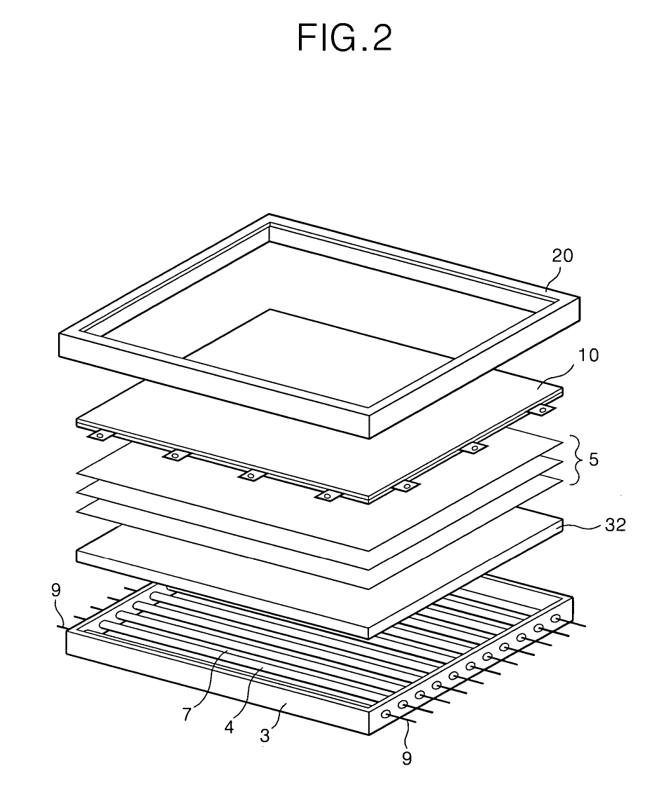

Referring to FIG. 2, a liquid crystal display (LCD) device according to an exemplary embodiment includes an LCD panel 10, a top case 20 disposed on the LCD panel 10, and a direct type backlight unit disposed on the rear surface of the LCD panel 10 to irradiate light to the LCD panel 10.

The LCD panel 10 includes a plurality of data lines and a plurality of scan lines arranged crossing each other, and liquid crystal cells arranged in an active matrix form between upper and lower substrates (not shown). Further, the LCD panel 10 includes pixel electrodes and a common electrode formed to apply electric field to each of the liquid crystal cells (not shown). In the intersections of the data lines and the scan lines, thin film transistors (TFTs) are formed to switch a data voltage applied to the pixel electrode in response to a scan signal (not shown). Gate drive integrated circuits and data drive integrated circuits are electrically connected to the LCD panel 10 through a tape carrier package (TCP) (not shown).

The backlight unit includes a plurality of lamps 4, a bottom cover 3, a reflection plate 7, a diffusion plate 32, a plurality of optical sheets 5 and a wire 9. The diffusion plate 32 is arranged corresponding to the location of the plurality of lamps 4 such that a density of beads within the diffusion plate 32 varies with respect to the location of the lamps 4. The plurality of lamps 4 are cold cathode fluorescent lamps (CCFLs) and arranged in series. Herein, the wire 9 is connected to an external power source that drives the plurality of lamps 4. The bottom cover 3 includes a bottom surface and a side surface. The reflection plate 7 is disposed in the bottom cover 3. The optical sheets 5 include a diffusion sheet and a prism sheet, and have the incident light from the diffusion plate 32 uniformly irradiated to the whole of the LCD panel 10. Also, the optical sheets 5 serve to increase the brightness in front of a display surface of the LCD panel 10 by bending the progress path of light in a direction perpendicular to the display surface.

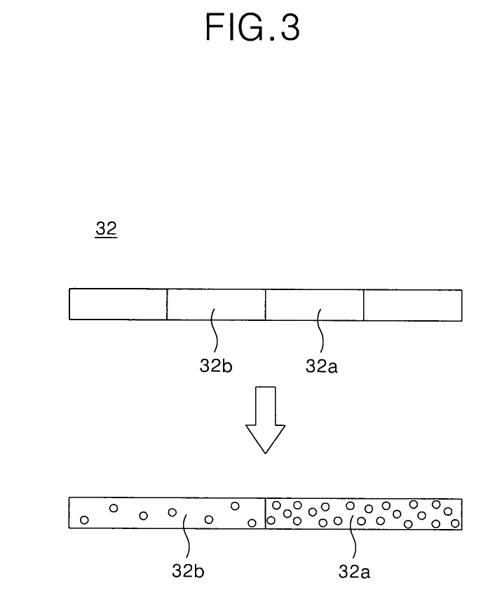

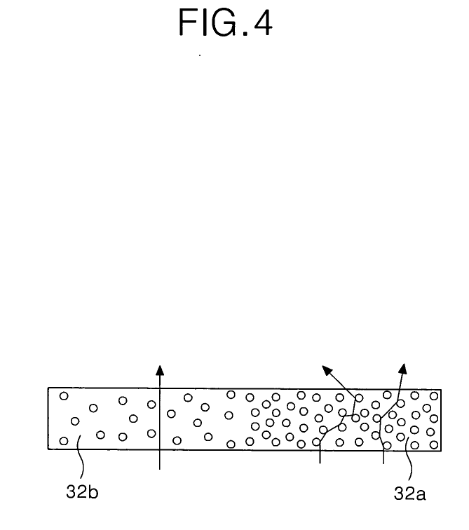

Referring to FIG. 3, the diffusion plate 32, which is located on the plurality of lamps 4, includes a first diffusion part 32a corresponding to an area where the lamp 4 is located and where the density of beads is high, and a second diffusion part 32b corresponding to an area where the lamp 4 is not located and where the density of beads is low. Generally, light goes straight ahead if a refractive index of a medium is the same, and the light is refracted to change its path or to be partially absorbed when encountering another medium. Accordingly, referring to FIG. 4, if the density of beads within the diffusion plate 32 varies, the light collides with the beads within the first diffusion part 32a, so that light paths are increased, thereby diffusing the light. On the other hand, the density of beads in the second diffusion part 32b is lower than that in the first diffusion part 32a and therefore, the light from the lamp 4 is transmitted intact.

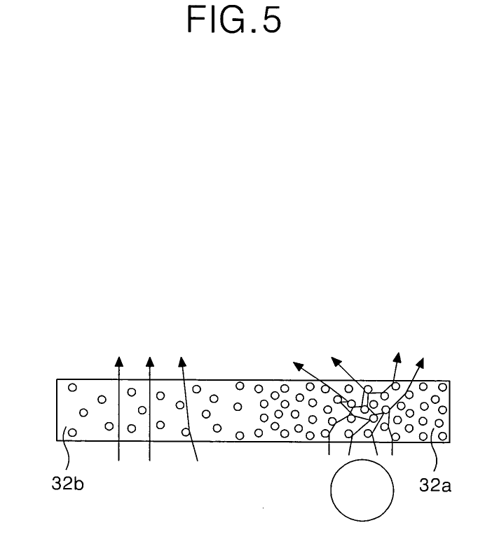

To describe this in detail, referring to FIG. 5, the first diffusion part 32a of the diffusion plate 32 is formed in an area where the lamp 4 is located and the density of beads is made high to induce the refraction and absorption of the light, thereby decreasing light intensity. On the other hand, the second diffusion part 32b of the diffusion plate 32 is formed in an area where the lamp 4 is not located and the density of beads is made low to have the transmittance of light higher so as to make the light intensity strong, thereby preventing darkness. Accordingly, the light transmitted through the first and second diffusion parts 32a, 32b of the diffusion plate 32 has its brightness difference-reduced in comparison with the related art, and thus a uniform light can be irradiated to the LCD panel 10.

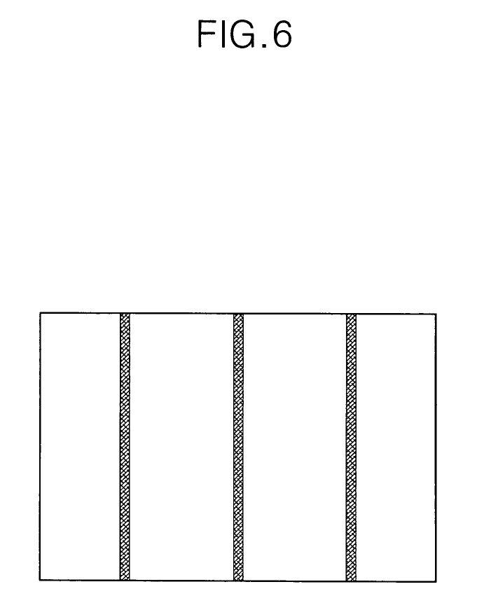

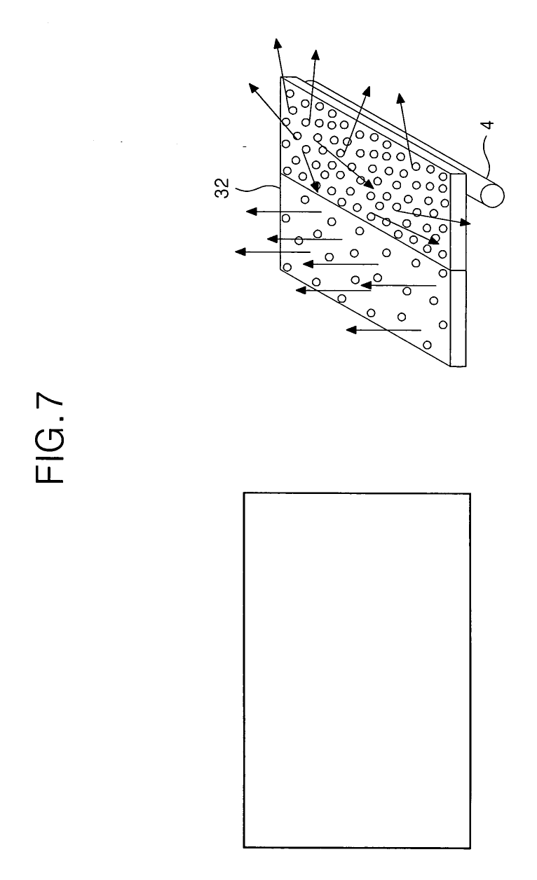

In the related art, since the density of beads in the diffusion plate is uniform, if a gap between the diffusion plate and the lamp is made narrower, as shown in FIG. 6, the light from the lamp becomes intensified so that a line of a bright band shape is shown in the display surface in correspondence to the lamp location and a dark part is generated. On the other hand, in case of using the diffusion plate where the density of beads is partially adjusted according to the exemplary embodiment of the present invention, as shown in FIG. 7, the display surface having the uniform brightness can be obtained because the part where the lamp 4 exists has high beads density to decrease the transmittance thereby decreasing the light brightness, whereas the part where the lamp 4 does not exist has low beads density so that the light from the lamp 4 is transmitted intact thereby increasing the light brightness. According to the methodology and arrangement of the exemplary embodiment, the diffusion plate 32 includes the beads that are unevenly distributed in accordance with the location of lamp 4 so that the light emitted from the diffusion plate 32 is uniform in brightness. Further, the distance between the lamp 4 and the diffusion plate 32 can be minimized in comparison with the related art, thereby slimming the thickness of the whole LCD device.

As another exemplary embodiment of the present invention, the beads may be mixed and injected into a diffusion sheet that is disposed between the diffusion plate and the LCD panel. The density of the beads may be made different in accordance with the location of lamps in the same manner as the foregoing embodiment. In a further exemplary embodiment of the present invention, as the diffusion plate or the diffusion sheet become more distant from the lamp, the density of beads therein may be gradually decreased in order.

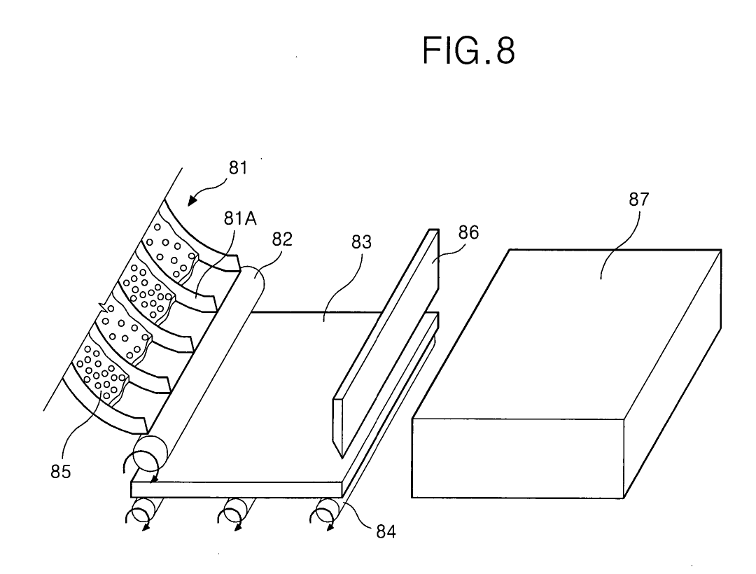

FIG. 8 is a perspective view illustrating a diffusion plate according to one exemplary embodiment of the present invention. Referring to FIG. 8, an apparatus for fabricating the diffusion plate includes a provider 81 having a plurality of barrier ribs 81A, a providing roller 82, a stage 83, and a moving roller 84 for moving the stage 83. Also, the providing roller 82 is rotatably installed between the provider 81 and the stage 83. Hereinafter, the method of fabricating the diffusion plate is described.

First of all, a transparent resin (for example, PMMA) 85 mixed with beads is provided to the provider 81. The plurality of barrier ribs 81A serve as partitions dividing paths for supplying the beads. Therefore, by means of the barrier ribs 81A, a supplying path for the transparent resin mixed with high density beads is separated from a supplying path for the transparent resin mixed with low density beads. The provider 81 provides the transparent resin 85 to the stage 83 via the providing roller 82. The stage 83 is also moved by moving rollers 84 arranged under the stage 83. The thickness of the transparent resin 85 may be adjusted to be uniform by a blade 86. Moreover, the stage 83 may be heated so as to pre-cure the transparent resin 85, thereby heightening the viscosity of the transparent resin 85 and lessening the fluidity of beads. The transparent resin 85 in a uniform thickness is cured at a curing temperature by the curing apparatus 87. After that, the transparent resin 85 is cut in a uniform size, and then is removed from the stage 83. Thus, a diffusion plate 87 is formed. To simplify the structure of the apparatus, the providing roller 82 may be removed. Also, in the apparatus of fabricating the diffusion plate according to the exemplary embodiment, it is possible to gradually adjust the density of beads by narrowing the gap between the barrier ribs.

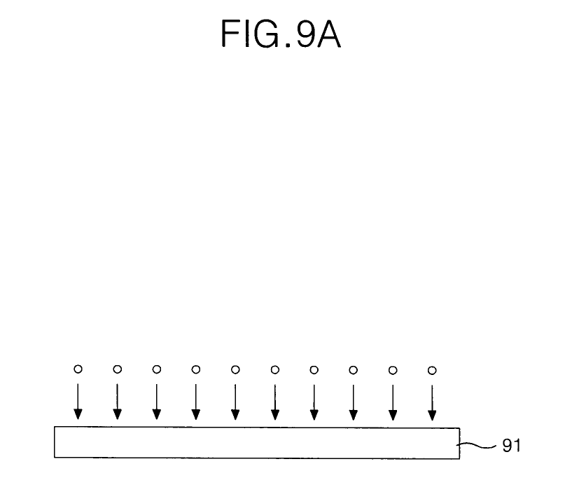

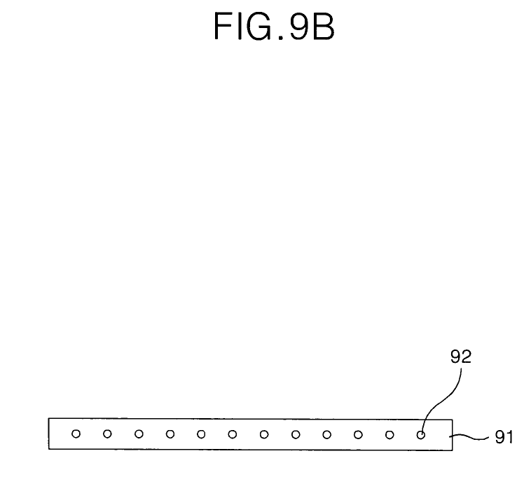

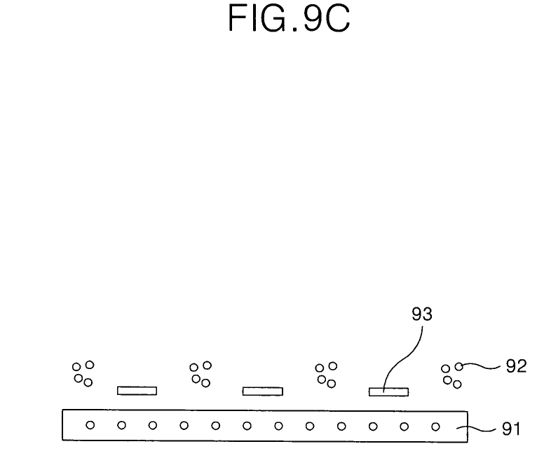

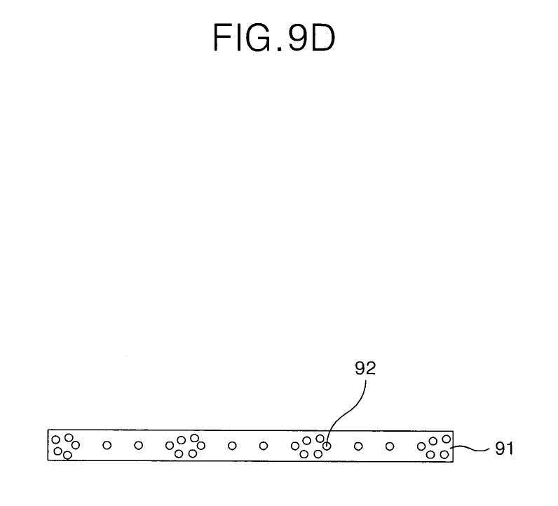

FIGS. 9A to 9D are sectional views showing the method of fabricating a diffusion plate according to the exemplary embodiment of the present invention. As shown in FIGS. 9A and 9B, in the method of fabricating the diffusion sheet, a few beads 92 are mixed with a liquefied transparent resin 91 in uniform, and the transparent resin 91 is pre-cured. As a result, the viscosity of the transparent resin 91 is heightened to lessen the fluidity of the beads 92. Also, in this exemplary embodiment, the liquefied transparent resin 91 may be formed on an elongated base film. Moreover, as shown in FIG. 9C, a mask 93 with openings is aligned on the pre-cured transparent resin 91, and then many beads 92 are supplied to the pre-cured transparent resin 91 through the mask 93. Thus, as shown in FIG. 9D, the diffusion sheet may be formed with the density of beads therein being varied.

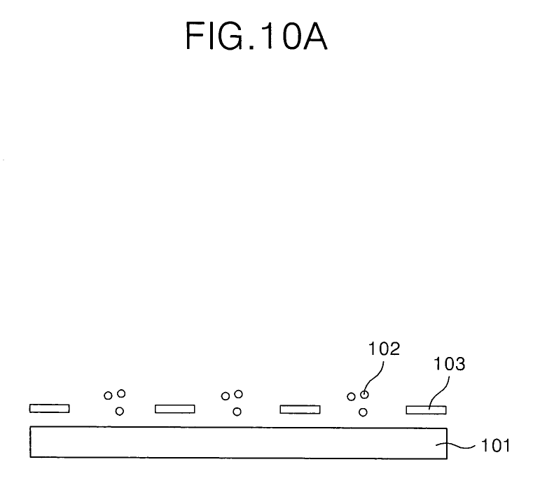

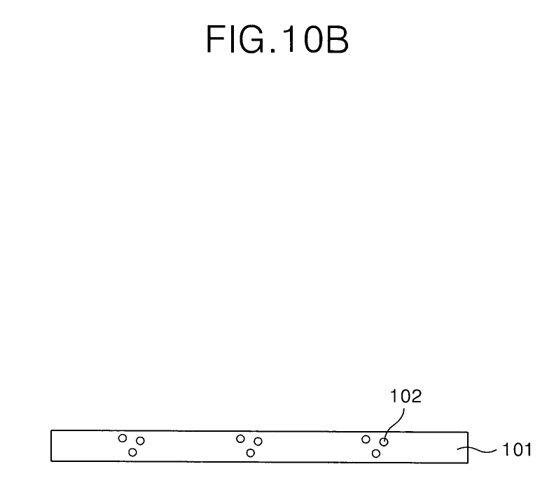

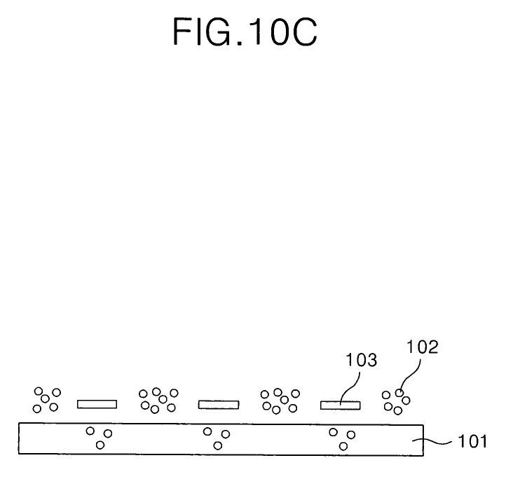

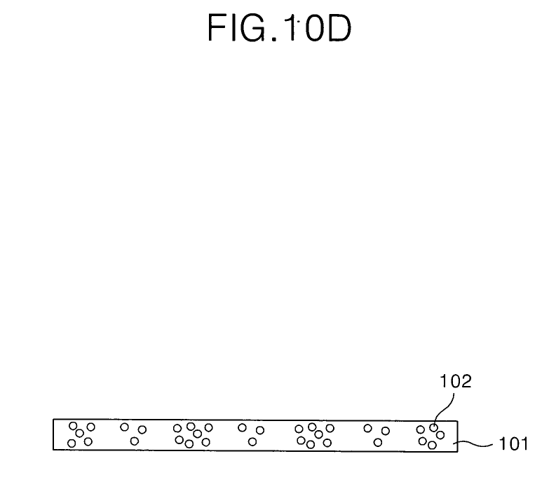

FIGS. 10A to 10D are sectional views illustrating the method of fabricating a diffusion plate according to another exemplary embodiment of the present invention. As shown in FIGS. 10A and 10B, in the method of fabricating the diffusion sheet, beads 102 are supplied to a liquefied transparent resin 101 such that a mask 103 is aligned at an initial alignment position, and the fluidity of the beads 102 in the transparent resin 101 is lowered at a pre-curing temperature. As shown in FIGS. 10C and 10D, the mask 102 is moved to change its alignment position, many beads 102 are supplied to the pre-cured transparent resin 101 through the mask 103, and then the transparent resin 101 is cured at a curing temperature.

As described above, according to the optical device and the fabricating method thereof in accordance with the exemplary embodiments, the thickness of the backlight unit can be formed slim by differently distributing the density of beads in the diffusion sheet based on the positions of the lamps. Also, according to the exemplary embodiments, a slim LCD device with a uniform brightness can be obtained by utilizing the slim backlight unit having the optical device.

It will be apparent to those skilled in the art that various modifications and variations can be made in the optical device, the method and apparatus of fabricating the optical device, a backlight unit using the optical device, and the LCD device using the backlight unit of the present invention without departing from the spirit or scope of the invention. Thus, it is intended that the present invention cover the modifications and variations of this invention provided they come within the scope of the appended claims and their equivalents.

What is claimed is:

1. An optical device for a light source in a liquid crystal display, comprising:
a diffusion plate including a first diffusion part and a second diffusion part such that the light source emits a first amount of light to the first diffusion part and a second amount of light to the second diffusion part; and
a plurality of beads included in both the first diffusion part and the second diffusion part,
wherein the density of the beads in the first diffusion part is different from that in the second diffusion part.

2. The optical device according to claim 1, further comprising optical sheets including at least a diffusion sheet and a prism sheet.

3. A backlight unit, comprising:
a light source;
a diffusion plate disposed on the light source and including a plurality of beads for diffusing a light from the light source, wherein the density of the beads is uneven; and
a plurality of optical sheets disposed on the diffusion plate.

4. The backlight unit according to claim 3, wherein the diffusion plate includes a first diffusion part and a second diffusion part, such that the density of the beads in the first diffusion is higher than that in the second diffusion, and the amount of light emitted from the light source to the first diffusion part is larger than that to the second diffusion part.

5. A backlight unit, comprising:
a light source;
a diffusion plate disposed on the light source to diffuse a light from the light source; and
a plurality of optical sheets disposed on the diffusion plate,
wherein the plurality of optical sheets includes at least one diffusion sheet that is provided with a plurality of beads, and the density of the beads is varied.

6. The-backlight unit according to claim 5, wherein the diffusion plate includes a plurality of beads and the density of the beads is varied.

7. The backlight unit according to claim 6, wherein each of the diffusion plate and the at least one diffusion sheet includes:
a first diffusion part including a first density of the beads; and
a second diffusion part including a second density of the beads,
wherein the first diffusion part is adjacent to the light source more than the second diffusion part, and the first density of the beads is higher than the second density of the beads.

8. A liquid crystal display (LCD) device, comprising:
a backlight unit including a light source, a diffusion plate disposed on the light source, and a plurality of optical sheets disposed on the diffusion plate; and
an LCD panel electrically controlling a liquid crystal to modulate a light irradiated from the backlight unit, thereby displaying a picture,
wherein the diffusion plate is provided with a plurality of beads for diffusing a light from the light source, and the density of the beads is varied.

9. The LCD device according to claim 8, wherein the diffusion plate includes:
a first diffusion part including a first density of beads in an area corresponding to a location of the light source; and
a second diffusion part including a second density of beads in an area other than the light source,
wherein the first density of the beads is higher than the second density of the beads.

10. A liquid crystal display (LCD) device, comprising:
a backlight unit including a light source, a diffusion plate disposed on the light source to diffuse a light from the light source, and a plurality of optical sheets disposed on the diffusion plate; and
an LCD panel electrically controlling a liquid crystal to modulate a light irradiated from the backlight unit, thereby displaying a picture,
wherein the plurality of optical sheets include at least one diffusion sheet that is provided with a plurality of beads, and the density of the beads is varied.

11. The LCD device according to claim 10, wherein the diffusion plate is provided with a plurality of beads and the density of the beads is varied.

12. The LCD device according to claim 11, wherein each of the diffusion plate and the at least one diffusion sheet includes:
a first diffusion part including a first density of beads in an area corresponding to a location of the light source; and
a second diffusion part including a second density of beads in an area other than the light source
wherein the first density of the beads is higher than the second density of the beads.

13. A method for fabricating an optical device, comprising:
providing a first transparent resin mixed with first beads on a moving stage through a first supply path and providing a second transparent resin mixed with second beads on the moving stage through a second supply path, wherein the number of the second beads are more than that of the first beads;
curing the first and second transparent resins provided to the moving stage; and
separating the first and second transparent resins from the moving stage.

14. The method according to claim 13, wherein the optical device includes a diffusion plate for a backlight unit.

15. A method for fabricating an optical device, comprising:
mixing a first beads with a liquefied transparent resin in uniform;
aligning a mask including an open part and a shielding part on the liquefied transparent resin;
providing the liquefied transparent resin with a second beads through the open part of the mask; and
curing the liquefied transparent resin mixed with the first and second beads, wherein the density of the first beads is different from that of the second beads in the cured transparent resin.

16. The method according to claim 15, further comprising;
pre-curing the liquefied transparent resin after the mixing step before the aligning step.

17. The method according to claim 15, wherein the optical device includes an optical sheet for a backlight unit.

18. A method for fabricating an optical device, comprising:
aligning a mask including an open part and a shielding part on a liquefied transparent resin;
providing the liquefied transparent resin with a first beads through the open part of the mask;
moving the mask;
providing the liquefied transparent resin with a second beads through the open part of the mask; and
curing the liquefied transparent resin mixed with the first and second beads,
wherein the density of the first beads is different from that of the second beads in the cured transparent resin.

19. The method according to claim 18, further comprising pre-curing the liquefied transparent resin after the step of providing the first beads before the step of providing the second beads.

20. The method according 18, wherein the optical device includes an optical sheet for a backlight unit.

21. An apparatus of fabricating an optical device, comprising;
a provider including a first supplying path for supplying a first transparent resin mixed with a first beads and a second supplying path for supplying a second transparent resin mixed with a second beads;
a plurality of barrier ribs formed on the provider for dividing the first supplying path and the second supplying path; and
a moving stage for receiving the first and second transparent resins from the provider.

22. The apparatus according to claim 21, further comprising;
a supplying roller rotationally installed between the provider and the moving stage; and
a moving roller for moving the moving stage.

23. The apparatus according to claim 22, wherein the moving stage is heated to a temperature to pre-cure the first and the second transparent resins.

24. The apparatus according to claim 21, further comprising;
a blading member to adjust the thickness of the first and the second transparent resins in uniform; and
a pre-curing member to cure the first and the second transparent resins at a curing temperature.

25. The Apparatus according to claim 21, wherein the optical device includes a diffusion plate for a backlight unit.

26. An apparatus of fabricating an optical device, comprising;
a mask including an opening part and a shielding part, wherein a plurality of beads is provided through the opening part to a liquefied transparent resin in various densities.

27. The apparatus according to claim 26, further comprises a curing member to cure the liquefied transparent resin at a curing temperature, wherein the mask is movable.

28. The apparatus according to claim 26, wherein the optical device includes an optical sheet for a backlight unit.
